(19) United States
(12) Patent Application Publication
(10) Pub. No.: US 2019/0009765 A1
(43) Pub. Date: Jan. 10, 2019

(54) ELECTROMECHANICAL BRAKE BOOSTER AND BRAKING SYSTEM

(71) Applicant: Robert Bosch GmbH, Stuttgart (DE)

(72) Inventors: Willi Nagel, Remseck/Hochdorf (DE); Daniel Weissinger, Korntal-Muenchingen (DE); Giammaria Panunzio, Ludwigsburg (DE); Andre Bollwerk, Steinheim An Der Murr (DE)

(21) Appl. No.: 16/064,272

(22) PCT Filed: Oct. 19, 2016
(86) PCT No.: PCT/EP2016/075021

§ 371 Date: Jun. 20, 2018

(30) Foreign Application Priority Data
Dec. 22, 2015 (DE) 10 2015 226 508.0

(51) Int. Cl. B60T 13/74; B60T 13/02

(52) U.S. Cl. CPC B60T 13/745; B60T 13/02

(57) ABSTRACT

An electromechanical brake booster for a motor vehicle, an input piston being guided by a bearing device on at least one support element, which is fastened on a transmission housing base of a transmission and extends in parallel to a predefined axis. Also described is a related braking system.

### FIELD OF THE INVENTION

The present invention relates to an electromechanical brake booster for a motor vehicle. The present invention moreover relates to a braking system.

### BACKGROUND INFORMATION

Alternative brake pressure buildup devices will be required for the future drive concepts of motor vehicles, since little or no vacuum is present for operating a conventional vacuum brake booster. Electromotive brake boosters have been configured for this purpose.

Patent document DE 10 2012 014 361 A1 discusses an actuating device for a master brake cylinder of a motor vehicle, including a housing to be situated between the master brake cylinder and a brake pedal, through which a pressure element for actuating an actuating piston of the master brake cylinder extends, an electric motor, a screw which is driven by the electric motor and intersects the pressure element, and a transmission situated in the housing, which couples the screw to the actuating piston so as to convert a rotational movement of the screw into a translational movement of the actuating piston.

If a failure of the electromotive boosting of a driver braking force occurs in an electromechanical brake booster, it has to be ensured that the driver braking force is applicable to an input piston guided in the booster piston, and the input piston is operable independently of the booster piston.

During an operation of the electromechanical brake booster, a tilting torque furthermore occurs between an input rod, an input piston, and a booster piston as a result of a generation of transverse forces and torque influences.

### SUMMARY OF THE INVENTION

The present invention is therefore based on the object of providing an improved electromechanical brake booster, which enables optimized mounting of the booster piston of the electromechanical brake booster, which is capable of compensating for occurring transverse forces and torque influences even in the case of the failure of the electromotive boosting of the driver braking force.

The object may be achieved by an electromechanical brake booster for a motor vehicle having the features described herein. Furthermore, the object is achieved by a braking system having the features described herein.

The present invention provides an electromechanical brake booster for a motor vehicle, an input piston being guided by a bearing device to at least one support element, which is fastened on a transmission housing base of a transmission and extends in parallel to a predefined axis.

The present invention furthermore provides a braking system including an electromechanical brake booster, and a master brake cylinder which is operable by the electromechanical brake booster.

One concept of the present invention is to compensate for an occurring tilting torque of the input piston by providing the bearing device, which guides the input piston in case of failure of the electromotive boosting of the driver braking force on at least one support element, which is fastened on a transmission housing base of a transmission and extends in parallel to the predefined axis.

Advantageous specific embodiments and refinements result from the subclaims and from the description with reference to the figures.

According to another refinement, it is provided that at least one first support element and one second support element are fastened as the at least one support element on the transmission housing base of the transmission, which extend in parallel to the predefined axis, the bearing device supporting the input piston on the first support element and on the second support element. Because of the support of the input piston on both the first support element and the second support element, a tilting torque occurring on the input piston may be effectively compensated for, and therefore an adjustment direction of the input piston extends linearly and in parallel to the predefined axis.

According to another refinement, it is provided that the bearing device is integrally formed with a valve body guided in the booster piston, which is operable by the input piston via a spring element situated in the booster piston and via an entraining element situated on the input piston. Due to the integral formation of the bearing device with the valve body, the valve body is guidable, on the one hand, along the booster piston and also along the at least one support element.

According to another refinement, it is provided that the bearing device has a first radial end section, which encloses the first support element, and the bearing device has a second radial end section, which encloses the second support element. Because of the ring-shaped formation of the particular radial end sections of the bearing device, a constructively simple and secure guiding of the valve body and thus of the input piston in the adjustment direction of the input piston may be enabled.

According to another refinement, it is provided that the input piston includes a first section for accommodating an input rod, the first section of the input piston being guided on an inner circumference of the booster piston, and the input piston including a second section, which is situated adjacent to the first section and has a smaller diameter than the first section. By providing the first section of the input piston with a larger diameter, the first section of the input piston being guided on the inner circumference of the booster piston, an effective accommodation of the input rod may be provided, the input piston formed in this manner being movable without tilting in the booster piston.

According to another refinement, it is provided that the spring element is situated in the area of the second section of the input piston, the spring element enclosing the input piston, and the spring element being situated in parallel to the predefined axis between the input piston and the booster piston. The spring element is therefore advantageously formed for the purpose, upon displacement of the input piston in parallel to the predefined axis, of guiding the valve body in parallel to the predefined axis by applying a spring force to the valve body.

According to another refinement, it is provided that the input piston is guided in the valve body guided in the booster piston, the valve body having a hollow-cylindrical section, which is inserted into the booster piston, and the input piston being inserted into the hollow-cylindrical section of the valve body. Due to the insertion of the input piston into the hollow-cylindrical section of the valve body, the input piston is therefore advantageously supported by the first section of the input piston, which is guided on an inner circumference of the booster piston, and by the guiding in the valve body, in such a way that the input piston is guidable securely and reliably in parallel to the predefined axis.

According to another refinement, it is provided that the booster piston has a thread formed on an outer circumference, a nut meshing with the thread of the booster piston being formed in one piece with a gearwheel of the transmission. A required number of transmission components may thus advantageously be reduced.

According to another refinement, it is provided that the nut has, on an inner circumference, an internal thread meshing with the thread of the booster piston, and the nut having teeth forming the gearwheel on an outer circumference. The nut therefore advantageously fulfills both the function of the drive of the booster piston via the thread and the function of the attachment to the electric motor/transmission unit.

According to another refinement, it is provided that the booster piston has a further bearing device integrally formed with the booster piston, by which the booster piston is guided on the at least one support element fastened on a transmission housing base of the transmission. The further bearing device of the booster piston is advantageously used for guiding the booster piston during an operation of the electromotive boosting of the driver braking force by providing a translational movement of the booster piston.

According to another refinement, it is provided that at least one restoring spring for restoring the booster piston is situated in such a way that in case of the failure of the electromotive boosting of the driver braking force, the valve body is displaceable in parallel to the predefined axis without a deformation of the at least one restoring spring. The restoring force of the restoring spring therefore advantageously acts only on the booster piston and in case of the failure of the electromotive boosting of the driver braking force, does not act against the valve body actuated by the driver. It therefore advantageously has to apply a lesser driver braking force, whereby a shorter braking distance is achievable with equal force application.

The described embodiments and refinements may be arbitrarily combined with one another.

Further possible embodiments, refinements, and implementations of the present invention also include combinations, which are not explicitly mentioned, of features of the present invention which were described above or hereafter with respect to the exemplary embodiments.

The appended drawings are to provide greater comprehension of the specific embodiments of the present invention. They illustrate specific embodiments and are used in conjunction with the description to explain principles and concepts of the present invention.

Other specific embodiments and many of the mentioned advantages result with respect to the drawings. The elements shown in the drawings are not necessarily shown true to scale in relation to one another.

In the figures of the drawings, identical reference numerals identify identical or functionally-identical elements, parts, or components, if not otherwise indicated.

### BRIEF DESCRIPTION OF THE DRAWINGS

FIG. 1 shows a longitudinal sectional view of an electromechanical brake booster for a motor vehicle according to one specific embodiment of the present invention.

FIG. 2 shows an enlarged partial view of the longitudinal sectional view shown in FIG. 1 of the electromechanical brake booster for the motor vehicle according to the specific embodiment of the present invention.

### DETAILED DESCRIPTION

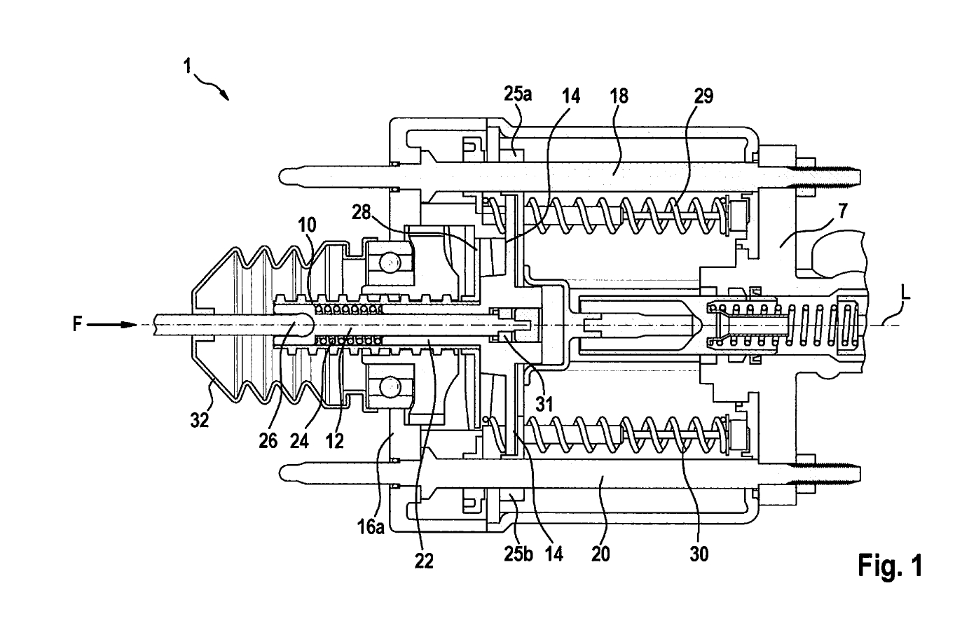

FIG. 1 shows a longitudinal sectional view of an electromechanical brake booster for a motor vehicle according to one specific embodiment of the present invention.

Electromechanical brake booster 1 for a motor vehicle may have an electric motor (not shown in FIG. 1). The electric motor is operationally connected to a booster piston 10 in such a way that an operation of the electric motor effectuates a translational movement of booster piston 10 for the electromotive boosting of a driver braking force F. Driver braking force F may be applicable to an input piston 12 guided in booster piston 10. In case of a failure of the electromotive boosting of driver braking force F, input piston 12 may be operable independently of booster piston 10.

Input piston 12 is furthermore guided by a bearing device 14 on a first support element 18, which is fastened on a transmission housing base 16a of transmission 16 and extends in parallel to a predefined axis L. Furthermore, input piston 12 is guided by bearing device 14 on a second support element 20, which is fastened on transmission housing base 16a of transmission 16 and extends in parallel to predefined axis L.

Bearing device 14 may be integrally formed with a valve body 22 guided in the booster piston. Valve body 22 may be operable by input piston 12 via a spring element 24 situated in booster piston 10 and via an entraining element 31 situated on input piston 12. Alternatively, valve body 22 may be operable, for example, via another suitable actuating element.

Bearing device 14 may include a first radial end section 25a. First radial end section 25a may be formed in a ring shape. Bearing device 14 furthermore has a second radial end section 25b. Second radial end section 25b may be formed in a ring shape. First radial end section 25a may enclose first support element 18. Second radial end section 25b may enclose second support element 20. Alternatively, bearing device 14 may also be guidable in another suitable way on the first and second support element.

Booster piston 10 may have a thread 10c formed on an outer circumference 10b. A nut 27 meshing with thread 10c of booster piston 10 may be formed in one piece with a gearwheel of transmission 16. Alternatively, the nut and the gearwheel may also be formed in multiple parts, for example. Nut 27 advantageously has, on an inner circumference, an internal thread 27a meshing with thread 10c of booster piston 10. The nut furthermore may have teeth 27b forming the gearwheel on an outer circumference.

Booster piston 10 may have a further bearing device 28 integrally formed with booster piston 10. Booster piston 10 is guided by further bearing device 28 on the at least one first and second support element fastened on transmission housing base 16a of transmission 16. Further bearing device 28 may be used for supporting booster piston 10 during an operation of electromechanical brake booster with electromotive boosting of driver braking force F.

A first restoring spring 29 for restoring booster piston 10 may be situated adjacent to first support element 18 in such a way that in the case of failure of the electromotive boosting of driver braking force F, valve body 22 is displaceable in parallel to predefined axis L without a deformation of first restoring spring 29.

Furthermore, a second restoring spring 30 for restoring booster piston 10, which is situated adjacent to second support element 20, may be situated in such a way that in case of the failure of the electromotive boosting of driver braking force F, valve body 22 is displaceable in parallel to predefined axis L without a deformation of second restoring spring 30.

This is advantageously achieved in that first and second restoring springs 29, 30 do not have contact with valve body 22, but rather only form contact with second bearing device 28.

Alternatively, first and second restoring springs 29, 30 may directly or indirectly form contact with booster piston 10. Booster piston 10 may be enclosed outside transmission 16 by a pair of bellows 32, which also at least partially encloses input rod 26.

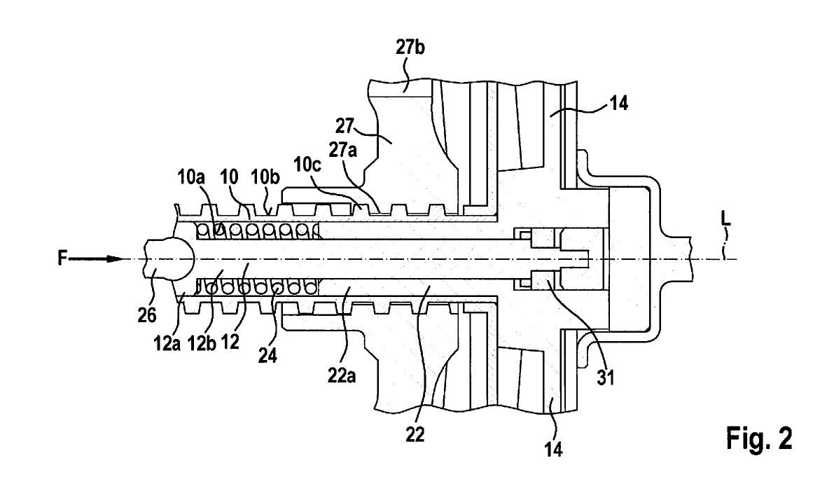

FIG. 2 shows an enlarged partial view of the longitudinal sectional view shown in FIG. 1 of the electromechanical brake booster for the motor vehicle according to the specific embodiment of the present invention.

Input piston 12 may have a first section 12a for accommodating input rod 26. First section 12a of input piston 12 may be guided on an inner circumference 10a of the booster piston. Input piston 12 moreover has a second section 12b situated adjacent to first section 12a, second section 12b having a smaller diameter than first section 12a.

Spring element 24 may be situated in the area of second section 12b of input piston 12. Spring element 24 encloses input piston 12. Spring element 24 may furthermore be situated in parallel to predefined axis L between input piston 12 and booster piston 10.

Input piston 12 may be guided in valve body 22, which is guided in booster piston 10. Valve body 22 may have a hollow-cylindrical section 22a. Hollow-cylindrical section 22a may be inserted into booster piston 10. Input piston 12 may be in turn inserted into hollow-cylindrical section 22a of valve body 22.

Although the present invention was described above on the basis of the exemplary embodiments, it is not restricted thereto, but rather may be modified in a variety of ways. In particular, the present invention may be changed or modified in manifold ways without departing from the core concept of the present invention.

For example, the bearing device for supporting the valve body on the support elements may also be configured in another suitable way. Moreover, a displaceability of the input piston in relation to the valve body and the booster piston may also be constructively achieved in another manner.

1-12. (canceled)

13. An electromechanical brake booster for a motor vehicle, comprising:
an electric motor, which is operationally connected to a booster piston so that an operation of the electric motor effectuates a translational movement of the booster piston along a predefined axis for the electromotive boosting of a driver braking force, the driver braking force being applicable to an input piston guided in the booster piston, and the input piston being operable independently of the booster piston in case of a failure of the electromotive boosting of the driver braking force;
wherein the input piston is guided by a bearing device on at least one support element, which is fastened on a transmission housing base of a transmission and extends in parallel to the predefined axis.

14. The electromechanical brake booster of claim 13, wherein a first support element and a second support element are fastened as the at least one support element on the transmission housing base of the transmission, which extend in parallel to the predefined axis of the electromechanical brake booster, the bearing device supporting the input piston on the first support element and on the second support element.

15. The electromechanical brake booster of claim 13, wherein the bearing device is integrally formed with a valve body, which is guided in the booster piston and is operable by the input piston via a spring element situated in the booster piston and via an entraining element situated on the input piston.

16. The electromechanical brake booster of claim 14, wherein the bearing device has a first radial end section, which encloses the first support element, and the bearing device has a second radial end section, which encloses the second support element.

17. The electromechanical brake booster of claim 13, wherein the input piston has a first section for accommodating an input rod, the first section of the input piston being guided on an inner circumference of the booster piston, and the input piston having a second section, which is situated adjacent to the first section and has a smaller diameter than the first section.

18. The electromechanical brake booster of claim 17, wherein the spring element is situated in the area of the second section of the input piston, the spring element enclosing the input piston, and the spring element being situated in parallel to the predefined axis between the input piston and the booster piston.

19. The electromechanical brake booster of claim 15, wherein the input piston is guided in the valve body guided in the booster piston, the valve body having a hollow-cylindrical section, which is inserted into the booster piston, and the input piston being inserted into the hollow-cylindrical section of the valve body.

20. The electromechanical brake booster of claim 13, wherein the booster piston has a thread formed on an outer circumference, a nut meshing with the thread of the booster piston being formed in one piece with a gearwheel of the transmission.

21. The electromechanical brake booster of claim 20, wherein the nut has, on an inner circumference, an internal thread meshing with the thread of the booster piston, and the nut has teeth forming the gearwheel on an outer circumference.

22. The electromechanical brake booster of claim 13, wherein the booster piston includes a further bearing device integrally formed with the booster piston, by which the booster piston is guided on the at least one support element fastened on the transmission housing base of the transmission.

23. The electromechanical brake booster of claim 13, wherein at least one restoring spring for restoring the booster piston is situated so that in the case of failure of the electromotive boosting of the driver braking force, the valve body is displaceable parallel to the predefined axis without a deformation of the at least one restoring spring.

24. A braking system, comprising:
an electromechanical brake booster for a motor vehicle, including an electric motor, which is operationally connected to a booster piston so that an operation of the electric motor effectuates a translational movement of the booster piston along a predefined axis for the electromotive boosting of a driver braking force, the driver braking force being applicable to an input piston guided in the booster piston, and the input piston being operable independently of the booster piston in case of a failure of the electromotive boosting of the driver braking force, wherein the input piston is guided by a bearing device on at least one support element, which is fastened on a transmission housing base of a transmission and extends in parallel to the predefined axis; and
a master brake cylinder, which is operable by the electromechanical brake booster.
